(19) United States
(12) Patent Application Publication
(10) Pub. No.: US 2022/0113165 A1
(43) Pub. Date: Apr. 14, 2022

(54) ROTOR APPARATUS AND ELECTRONIC DEVICE

(71) Applicant: SAMSUNG ELECTRO-MECHANICS CO., LTD., Suwon-si (KR)

(72) Inventors: Su Bong JANG, Suwon-si (KR); Hee Soo YOON, Suwon-si (KR); Sang Jong LEE, Suwon-si (KR)

(73) Assignee: SAMSUNG ELECTRO-MECHANICS CO., LTD., Suwon-si (KR)

(21) Appl. No.: 17/148,665

(22) Filed: Jan. 14, 2021

(30) Foreign Application Priority Data
Oct. 13, 2020 (KR) 10-2020-0132102

(51) Int. Cl. G01D 5/20; G01B 7/30

(52) U.S. Cl. CPC G01D 5/20; G01B 7/30

(57) ABSTRACT

A rotor apparatus includes: a rotor configured to rotate around a rotational axis; a first angular position identification layer surrounding the rotational axis, configured to rotate with the rotor, and having a varying width; and a second angular position identification layer surrounding the rotational axis, configured to rotate with the rotor, and having a varying width. An angular position of the rotor corresponding to a maximum width of the first angular position identification layer is different from an angular position of the rotor corresponding to a maximum width of the second angular position identification layer. The maximum width of the first angular position identification layer is less than or equal to 1.2 times a maximum width of a corresponding first inductor. The maximum width of the second angular position identification layer is less than or equal to 1.2 times a maximum width of a corresponding second inductor.

### CROSS-REFERENCE TO RELATED APPLICATIONS

This application claims the benefit under 35 U.S.C. § 119(a) of Korean Patent Application No. 10-2020-0132102 filed on Oct. 13, 2020 in the Korean Intellectual Property Office, the entire disclosure of which is incorporated herein by reference for all purposes.

### BACKGROUND

### 1. Field

The present disclosure relates to a rotor apparatus and an electronic device. For example, the rotor apparatus may be configured to provide improved identification of angular position.

### 2. Description of Related Art

Recently, types and designs of electronic devices have been diversified. User demands for electronic devices have also been diversified, and a variety of requirements have been suggested for functions and designs of electronic devices.

Accordingly, an electronic device may include a rotor configured to perform various functions demanded by users, through efficient movement and design of the rotor.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a rotor apparatus includes: a rotor configured to rotate around a rotational axis; a first angular position identification layer disposed to surround the rotational axis, configured to rotate according to rotation of the rotor, and having a width varying with angular positions of the rotor; and a second angular position identification layer disposed to surround the rotational axis, configured to rotate according to the rotation of the rotor, and having a width varying with the angular positions of the rotor. An angular position of the rotor, among the angular positions of the rotor, corresponding to a maximum width of the first angular position identification layer is different from an angular position of the rotor, among the angular positions of the rotor, corresponding to a maximum width of the second angular position identification layer. The maximum width of the first angular position identification layer is less than or equal to 1.2 times a maximum width, in a direction corresponding to a direction of the maximum width of the first angular position identification layer, of a first inductor configured to output magnetic flux towards the first angular position identification layer. The maximum width of the second angular position identification layer is less than or equal to 1.2 times a maximum width, in a direction corresponding to a direction of the maximum width of the second angular position identification layer, of a second inductor configured to output magnetic flux towards the second angular position identification layer.

The first and second angular position identification layers may be disposed such that a portion corresponding to the maximum width of the first angular position identification layer and a portion corresponding to the maximum width of the second angular position identification layer do not overlap each other in a rotation direction of the rotor.

The maximum widths of the first and second angular position identification layers may occur once per one turn around the rotational axis. A minimum width of each of the first and second angular position identification layers may occur once per one turn around the rotational axis.

The first and second angular position identification layers may have substantially the same shape. One of the first and second angular position identification layers may be disposed to rotate further than the other of the first and second angular position identification layers by approximately ¼ turn and to surround a side surface of the rotor.

A width of a center portion between a portion corresponding to the maximum width of the first angular position identification layer and a portion corresponding to the minimum width of the first angular position identification layer may be equal to an average value of the maximum width of the first angular position identification layer and the minimum width of the first angular position identification layer. A width of a center portion between a portion corresponding to the maximum width of the second angular position identification layer and a portion corresponding to the minimum width of the second angular position identification layer may be equal to an average value of the maximum width of the second angular position identification layer and the minimum width of the second angular position identification layer.

Each of the first and second angular position identification layers may have a sinusoidal-wave shaped boundary line.

The rotor apparatus may further include: a first inductor including a first coil pattern having a quadrangular shape; and a second inductor including a second coil pattern having a quadrangular shape.

The first coil pattern may be wound a plurality of times. The second coil pattern may be wound a plurality of times. The maximum width of the first inductor may be a maximum width of an outermost winding of the first coil pattern in the direction corresponding to the direction of the maximum width of the first inductor. The maximum width of the second inductor may be a maximum width of an outermost winding of the second coil pattern in a direction corresponding to a direction of the maximum width of the second inductor.

A minimum width of the first angular position identification layer may be less than a minimum width of an innermost winding of the first coil pattern in a direction corresponding to a direction of the minimum width of the first angular position identification layer. A minimum width of the second angular position identification layer may be less than a minimum width of an innermost winding of the second coil pattern in a direction corresponding to the minimum width of the second angular position identification layer.

The maximum width of the first angular position identification layer may be less than or equal to 1.1 times a maximum width of the first inductor in the direction corresponding to the direction of the maximum width of the first angular position identification layer. The maximum width of the second angular position identification layer may be less than or equal to 1.1 times a maximum width of the second inductor in a corresponding direction.

The maximum width of the first angular position identification layer may be greater than 0.9 times the maximum width of the first inductor in a corresponding direction. The maximum width of the second angular position identification layer may be greater than 0.9 times the maximum width of the second inductor in a corresponding direction.

The rotor apparatus may further include: a permeability layer disposed to surround the rotational axis and having a permeability higher than a permeability of the rotor.

Each of the first and second angular position identification layers may be disposed on a side surface of the rotor. The permeability layer may be disposed to overlap the first and second angular position identification layers in a normal direction of the side surface of the rotor.

Each of the first and second angular position identification layers may include any one or any combination of any two or more of copper, silver, gold, and aluminum. The rotor may include a plastic material.

Each of the first and second angular position identification layers may include any one or any combination of any two or more of copper, silver, gold, and aluminum. The rotor may have a permeability higher than a permeability of each of the first and second angular position identification layers.

In another general aspect, an electronic device includes: the rotor apparatus of claim 1; first and second inductors; and a processor configured to generate an angular position value by arc-tangent processing a value including a denominator variable corresponding to one of inductances of the first and second inductors and a numerator variable corresponding to a remaining inductance.

The electronic device may further include: a fixing member having a through-hole penetrated by the rotor; and a substrate disposed on the fixing member, wherein the first and second inductors are disposed on the substrate.

The electronic device may further include: a display member configured to output display information based on the angular position value, wherein a direction of the rotational axis is different from a direction in which the display member outputs the display information.

The electronic device may further include: a main body accommodating the processor; and a strap coupled to a second side surface of the main body and more flexible than the main body, wherein the rotor apparatus is disposed on a first side surface of the main body.

In another general aspect, a rotor apparatus includes: a rotor configured to rotate around a rotational axis; a first angular position identification layer disposed on a surface of the rotor around the rotational axis, and having a non-uniform width in a direction of the rotational axis; and a second angular position identification layer disposed on the surface of the rotor around the rotational axis, and having a non-uniform width in the direction of the optical axis. A maximum width of the first angular position identification layer and a maximum width of the second angular position identification layer are located at different angular positions of the rotor. The maximum width of the first angular position identification layer in a direction of the rotational axis is less than or equal to 1.2 times a maximum width of a first inductor corresponding to the first angular position identification layer. The maximum width of the second angular position identification layer is less than or equal to 1.2 times a maximum width of a second inductor corresponding to the second angular position identification layer.

The second angular position identification layer may be spaced apart from the first angular position identification layer in the direction of the rotational axis.

The rotor may have a permeability higher than a permeability of each of the first and second angular position identification layers.

The maximum widths of the first and second angular position identification layers may occur only once per one turn around the rotational axis.

Other features and aspects will be apparent from the following detailed description, the drawings, and the claims.

### BRIEF DESCRIPTION OF DRAWINGS

FIG. 1 is an exploded view illustrating a rotor apparatus, according to an example.

FIGS. 2A and 2B are perspective views illustrating an angular position identification layer included in rotor apparatuses, according to examples.

FIGS. 3A and 3B are perspective views illustrating a permeability layer included in rotor apparatuses, according to examples.

FIGS. 4A and 4B are perspective views illustrating first and second angular position identification layers included in rotor apparatuses, according to examples.

FIG. 5A is a perspective view illustrating a rotor apparatus, according to an example.

FIGS. 5B to 5C are lateral views illustrating the rotor apparatus of FIG. 5A.

FIG. 6 is a view illustrating a corresponding relationship between a width and an angular position of an angular position identification layer of a rotor apparatus, according to an example.

FIG. 7 is an exploded view illustrating a side surface of a rotor of the rotor apparatus of FIG. 5C, according to an example.

FIGS. 8A to 8D are views illustrating a relationship between a width of an angular position identification layer and a width of an inductor of a rotor apparatus, according to an example.

FIG. 9 is a graph illustrating inductance (a median normalized) of an inductor according to an angular position of a rotor of the rotor apparatus illustrated in FIGS. 8B to 8D, according to an example.

FIG. 10 is a graph illustrating inductance of an inductor according to a width of an angular position identification layer of a rotor apparatus, according to an example.

FIGS. 11A and 11D are graphs illustrating an arc-tangent processing value according to a width of an angular position identification layer of a rotor apparatus, according to examples.

FIGS. 12A and 12B are views illustrating an electronic device including a rotor apparatus, according to examples.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed, as will be apparent after gaining an understanding of this disclosure, with the exception of operations necessarily occurring in a certain order. Also, descriptions of features known in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is to be noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape occurring during manufacturing.

The features of the examples described herein may be combined in various ways as will be apparent after gaining an understanding of the disclosure of this application. Further, although the examples described herein have a variety of configurations, other configurations are possible as will be apparent after gaining an understanding of the disclosure of this application.

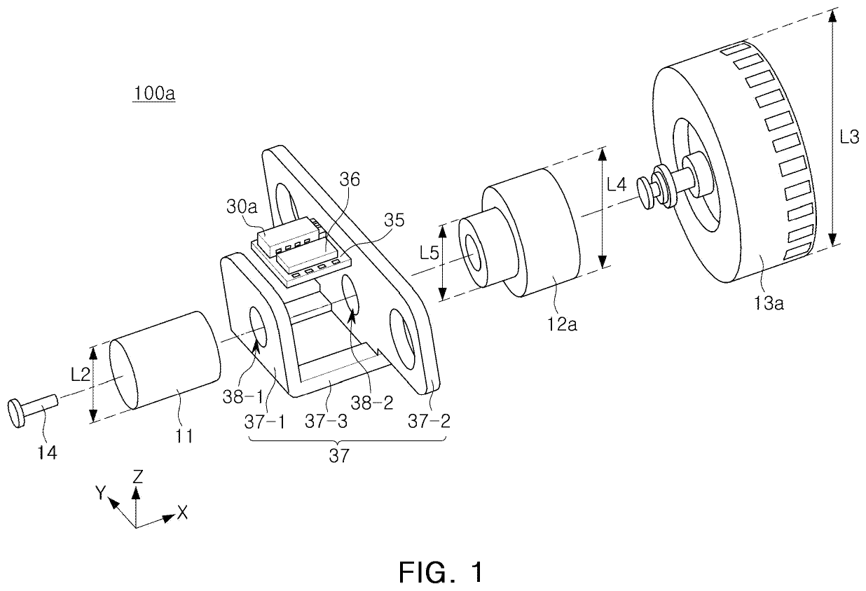

FIG. 1 is an exploded view illustrating a rotor apparatus 100a, according to an example.

Referring to FIG. 1, the rotor apparatus 100a may include, for example a rotor 11, a rotating connector 12a, a rotating head 13a, a pin 14, an inductor 30a, a substrate 35, an angular position sensing circuit 36, and a fixing member 37.

One end of the rotor 11 may be coupled to the rotating head 13a through the rotating connector 12a, and the other end of the rotor 11 may be coupled to the pin 14. A structure in which the rotor 11, the rotating connector 12a, the rotating head 13a, and the pin 14 are coupled to one another may rotate around a rotational axis (e.g., X axis). That is, the rotor 11, the rotating connector 12a, the rotating head 13a, and the pin 14 may rotate together around the rotational axis (e.g., X axis). For example, the rotor 11 may have a cylindrical shape or a polygonal column (e.g., an octagonal column) shape.

The rotating head 13a may be configured such that torque may be efficiently applied from an external entity. For example, the rotating head 13a may have a plurality of grooves configured such that a human hand does not slide while the hand is in contact with the rotating head 13a. For example, the rotating head 13a may have a diameter L3 greater than a diameter L2 of the rotor 11, such that a human hand can effectively exert force on the rotating head 13a. For example, the rotating head 13a may be a crown of a watch.

For example, either one or both of the rotor 11 and the rotating head 13a may include a plastic material. Accordingly, the rotor apparatus 100a may be lightweight, such that the rotor 11 and the rotating head 13a may be rotated by a human hand.

The rotating connector 12a may be configured to efficiently rotate according to the torque applied to the rotating head 13a. For example, the rotating connector 12a may have a spindle structure, and may be coupled to the rotating head 13a by screw connection. For example, the rotating connector 12a may have a cylindrical shape in which a diameter L4 of one end of the rotating connector 12a is different from a diameter L5 of the other end of the rotating connector 12a.

The structure in which the rotor 11, the rotating connector 12a, the rotating head 13a, and the pin 14 are coupled to one another may be disposed on the fixing member 37. The fixing member 37 may be configured to be fixed to an electronic device.

For example, the fixing member 37 may have a structure in which a first part 37-1, a second part 37-2, and a third part 37-3 are coupled to one another. The first and second parts 37-1 and 37-2 may have first and second through holes 38-1 and 38-2, respectively, and the third part 37-3 may be connected between the first and second parts 37-1 and 37-2 and may be configured to extend perpendicular to the first and second parts 37-1 and 37-2.

The rotor 11 may be disposed to penetrate at least one of the first and second through holes 38-1 and 38-2. Accordingly, the rotor 11 may maintain a spacing distance from the inductor 30a during rotation and may stably rotate. Thus, the rotor 11 may have longer lifespan.

The fixing member 37 may fix a positional relationship between the inductor 30a and the rotor 11. For example, the inductor 30a may be fixed on the substrate 35, and the substrate 35 may be fixed on the fixing member 37.

The substrate 35 may have a structure in which at least one wiring layer and at least one insulating layer are alternately stacked, such as a printed circuit board (PCB), and the inductor 30a may be electrically connected to the wiring layer of the substrate 35.

The angular position sensing circuit 36 may be disposed on the substrate 35 and may be electrically connected to the inductor 30a through a wiring layer of the substrate 35. For example, the angular position detection circuit 36 may be implemented as an integrated circuit, and may be mounted on the upper surface of the substrate 35.

The angular position sensing circuit 36 may generate an angular position value on the basis of inductance of the inductor 30a. For example, the angular position detection circuit 36 may output an output signal to the inductor 30a, and may receive an input signal based on the output signal and inductance of the inductor 30a. Since a resonant frequency of the output signal may be dependent on inductance of the inductor 30a, the angular position detection circuit 36 may recognize inductance of the inductor 30a by detecting the resonant frequency of the output signal, and may generate an angular position value corresponding to the inductance of the inductor 30a.

The inductor 30a may form magnetic flux according to the output signal received from the angular position sensing circuit 36. The inductor 30a may be disposed to output magnetic flux towards the rotor 11. For example, the inductor 30a may have a coil shape, and may have a structure in which at least one coil layer and at least one insulation layer, each including a wound wire, are alternately stacked.

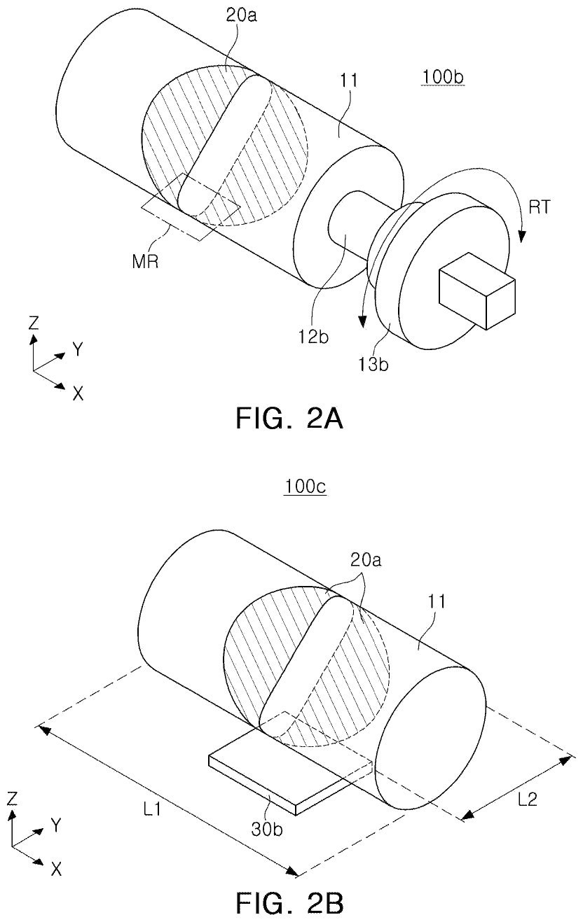

FIGS. 2A and 2B are perspective views illustrating an angular position identification layer 20a included in rotor apparatuses 100b and 100c, according to examples.

Referring to FIG. 2A, the rotor apparatus 100b may include the rotor 11 and an angular position identification layer 20a.

The rotor 11 may be configured to rotate in a clockwise (RT) direction or a counterclockwise direction along a rotational axis (e.g., X axis). Magnetic flux around the rotor 11 may pass through magnetic flux region MR of a side surface of the rotor 11. An angular position of the magnetic flux region MR may be determined according to the rotation of the rotor 11.

The angular position identification layer 20a may be disposed to surround the side surface of the rotor 11 and may have a width varying depending on the angular position of the rotor 11. For example, the angular position identification layer 20a may be plated on the side surface of the rotor 11, and may be inserted into the rotor 11 in the form of a ring in a state of being manufactured beforehand.

The magnetic flux passing through the magnetic flux region MR on the side surface of the rotor 11 may form an eddy current of the angular position identification layer 20a. Since a direction of the eddy current is similar to a direction of current of the coil, the eddy current may work as a parasitic inductor and may provide parasitic inductance.

The greater the diameter of the coil, the greater the inductance of the coil may be, and the greater the diameter of the region forming the eddy current, the greater the inductance according to the eddy current may be.

The greater the width of a portion corresponding to the magnetic flux region MR in the angular position identification layer 20a, the greater the diameter of the region forming the eddy current may be.

Since the width of the angular position identification layer 20a may vary according to the angular position of the rotor 11, the diameter of the region forming the eddy current formed on the angular position identification layer 20a may vary according to the angular position of the rotor 11. In other words, the inductance according to the eddy current dependent on the magnetic flux passing through the magnetic flux region MR may vary according to the angular position of the rotor 11.

Thus, the angular position identification layer 20a may provide inductance dependent on a degree of rotation of the rotor 11.

Precision and accuracy of the angular position identification of the rotor 11 may be higher as a rate of change of the inductance of the eddy current according to the change in width of the angular position identification layer 20a increases.

The rotor 11 may have permeability higher than permeability of the angular position identification layer 20a. Accordingly, precision and accuracy of the angular position identification of the rotor 11 may be improved.

For example, the rotor 11 may be implemented by a magnetic material such as ferrite, steel, iron, or nickel.

For example, the angular position identification layer 20a may include at least one of copper, silver, gold, and aluminum. Accordingly, the angular position identification layer 20a may have high conductivity such that the angular position identification layer 20a may form a larger eddy current. In general, a metal having high conductivity may have low permeability. Since the rotor 11 has a relatively high permeability, the rotor apparatus 100b may use an eddy current formed on the basis of high conductivity and inductance formed on the basis of high permeability, such that precision and accuracy of the angular position identification may be improved.

One end of the rotor 11 may be coupled to the rotating head 13b through the rotating connector 12b. The rotating head 13b may include a plastic material. Accordingly, although the rotor apparatus 100b may include the rotor 11 having a relatively heavy weight, the rotor apparatus 100b may have a relatively light weight such that the rotor apparatus 100b may easily receive an external torque.

Referring to FIG. 2B, the rotor apparatus 100c may have a structure in which a rotating connector (e.g., the rotating connector 12b) and a rotating head (e.g., the rotating head 13b) are not provided.

The inductor 30b may be disposed to overlap the angular position identification layer 20a in a normal direction of the side surface of the rotor 11.

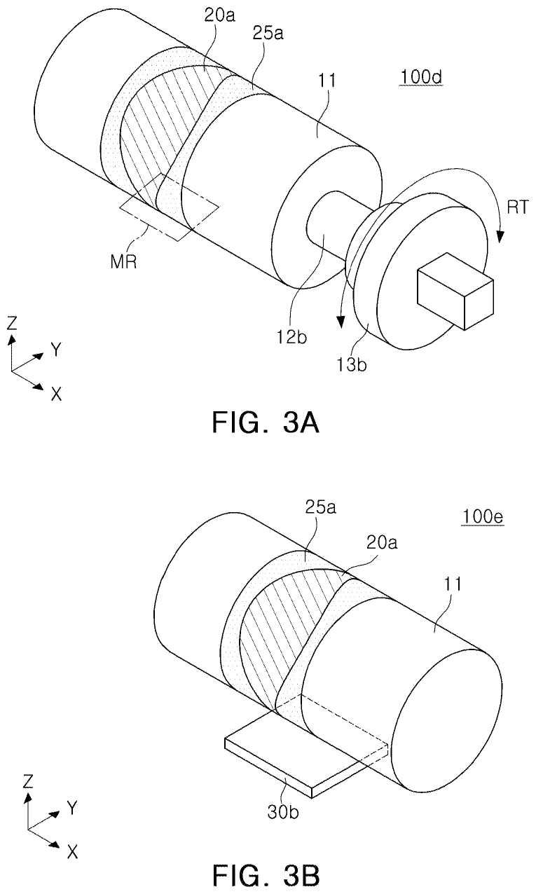

FIGS. 3A and 3B are perspective views illustrating a permeability layer 25a included in rotor apparatuses 100d and 100e, according to examples.

Referring to FIG. 3A, the rotor apparatus 100d may include the rotor 11, the angular position identification layer 20a, and a permeability layer 25a. The permeability layer 25a may not be provided, depending on a design objective.

The permeability layer 25a may be disposed to surround a side surface of the rotor 11 and may have permeability higher than permeability of the rotor 11. Accordingly, precision and accuracy of angular position identification of the rotor 11 may be improved.

Also, since the permeability layer 25a may provide a relatively high permeability, a material of the rotor 11 may not be limited to any particular material. For example, the rotor 11 may not have a higher permeability than the permeability of the angular position identification layer 20a, may include a plastic material to be relatively lightweight, and may be implemented as a material cheaper than a magnetic material.

For example, the permeability layer 25a may be implemented by a magnetic material such as ferrite, steel, iron, and nickel, may be plated on the side surface of the rotor 11 (e.g., nickel plating), and may be inserted into the rotor 11 in a ring shape in a state of being manufactured beforehand (e.g., manufactured according to a steel making process).

For example, the permeability layer 25a may be disposed to overlap the angular position identification layer 20a in a normal direction of the side surface of the rotor 11. Accordingly, a rate of change of the inductance of the eddy current according to the change in width of the angular position identification layer 20a may further increase, such that precision and accuracy of the angular position identification of the rotor 11 may be improved.

Referring to FIG. 3B, the rotor apparatus 100e may have a structure in which a rotating connector (e.g., the rotating connector 12b) and a rotating head (e.g., the rotating head 13b) are not provided.

The inductor 30b may be disposed to overlap the permeability layer 25a in the normal direction of the side surface of the rotor 11.

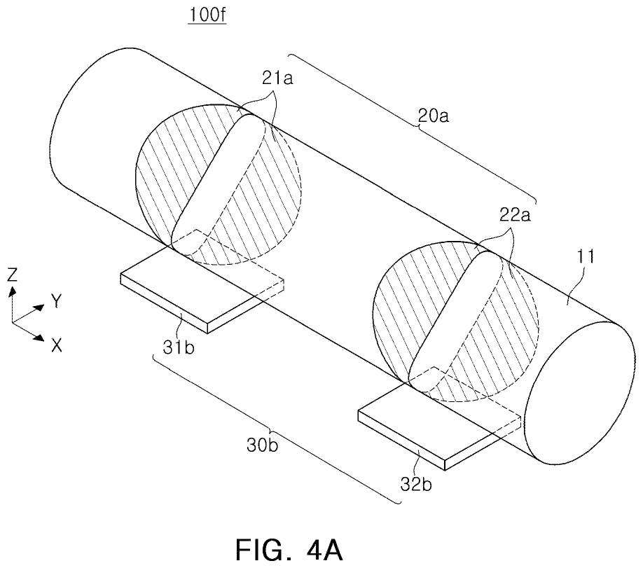

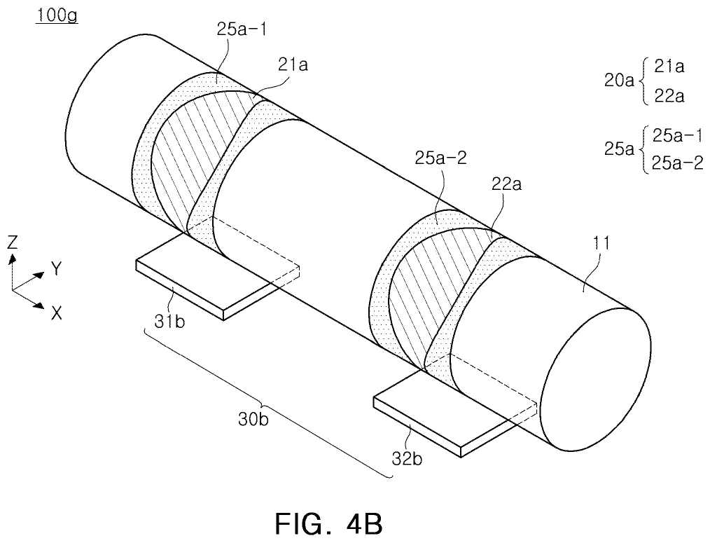

FIGS. 4A and 4B are perspective views illustrating first and second angular position identification layers 21a and 22a included in rotor apparatuses 100f and 100g, according to examples.

Referring to FIG. 4A, the angular position identification layer 20a of the rotor apparatus 100f may include first and second angular position identification layers 21a and 22a, and the inductor 30b may include first and second inductors 31b and 32b.

The first angular position identification layer 21a may be disposed to surround the side surface of the rotor 11 and may have a width varying depending on an angular position of the rotor 11.

The second angular position identification layer 22a may be disposed to be spaced apart from the first angular position identification layer 21a and to surround the side surface of the rotor 11 and may have a width varying depending on the angular position of the rotor 11.

Changes in the first and second inductance of the first and second inductors 31b and 32b according to the first and second eddy currents of the first and second angular position identification layers 21a and 22a according to the rotation of the rotor 11 may also be used for the angular position identification of the rotor 11.

Accordingly, an excessive increase in difference between a maximum width and a minimum width of each of the first and second angular position identification layers 21a and 22a may be prevented, such that linearity of inductance change according to changes in the width of each of the first and second angular position identification layers 21a and 22a may be improved.

Referring to FIG. 4B, the permeability layer 25a of the rotor apparatus 100g may include first and second permeability layers 25a-1 and 25a-2.

The first permeability layer 25a-1 may be disposed to surround the side surface of the rotor 11, may have a higher permeability than a permeability of the rotor 11 and may have a width greater than a maximum width of the first angular position identification layer 21a.

The second permeability layer 25a-2 may be disposed to be spaced apart from the first permeability layer 25a-1 and to surround the side surface of the rotor 11, may have a higher permeability than the permeability of the rotor 11, and may have a width greater than the maximum width of the second angular position identification layer 22a.

Accordingly, electromagnetic independence between the first and second angular position identification layers 21a and 22a may increase such that precision and accuracy of the angular position identification of the rotor 11 may be improved.

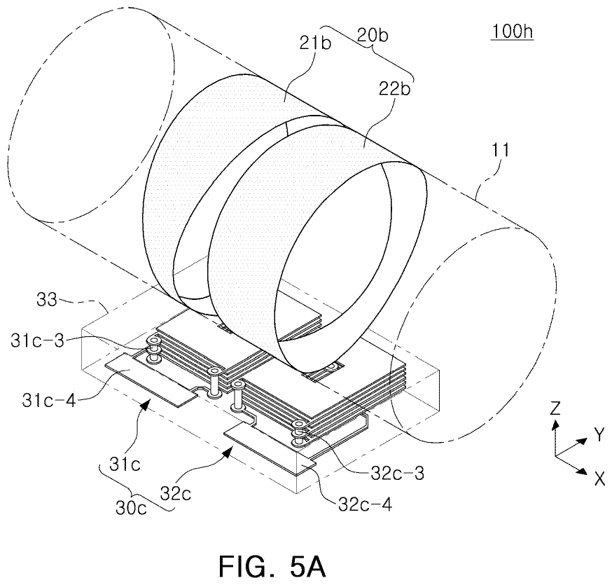

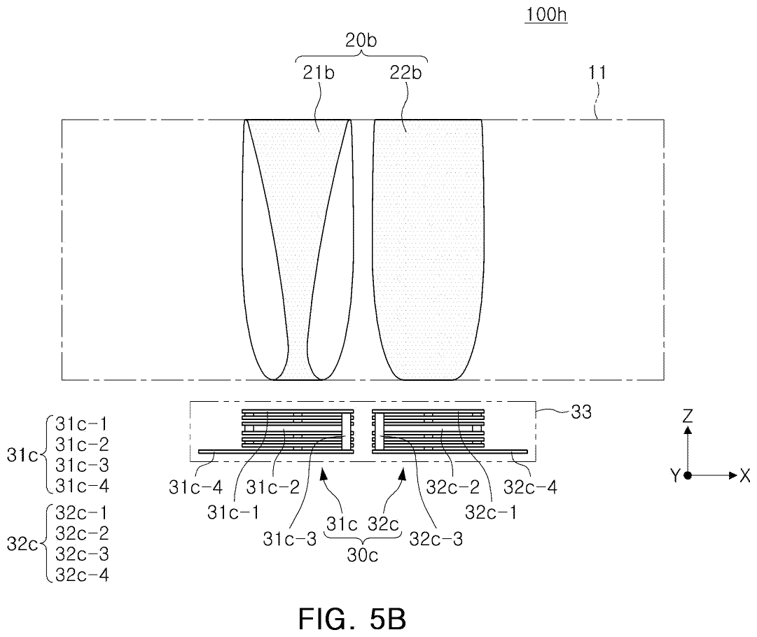

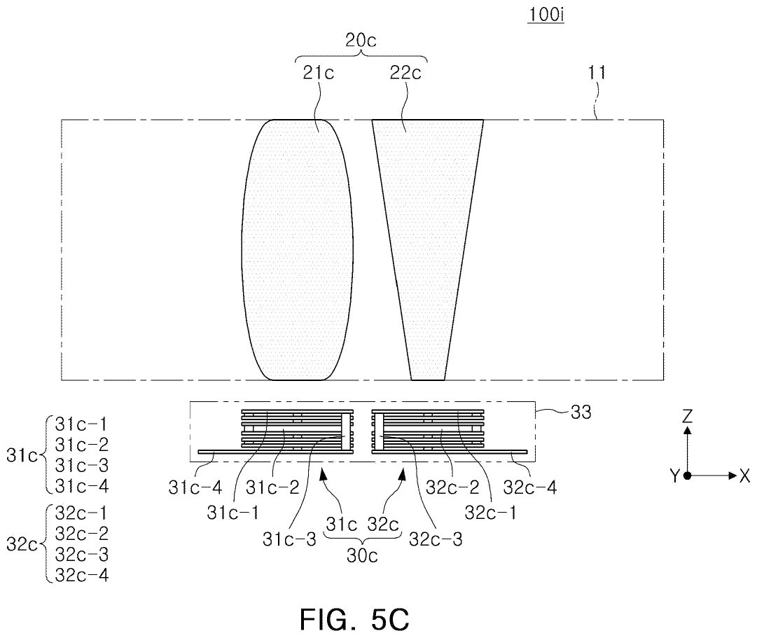

FIG. 5A is a perspective view illustrating a rotor apparatus 100h, according to an example. FIGS. 5B to 5C are lateral views illustrating the rotor apparatus 100h.

Referring to 5A and 5B, the rotor apparatus 100h may include the rotor 11 and an angular position identification layer 20b, and may further include an inductor 30c.

The inductor 30c may include a first inductor 31c and a second inductor 32c. The first inductor 31c may be disposed to output magnetic flux towards the first angular position identification layer 21b, and the second inductor 32c may be disposed to output magnetic flux towards the second angular position identification layer 22b.

For example, the first inductor 31c may have a stack structure in which at least one first coil pattern 31c-1 and at least one first coil insulating layer 31c-2 are alternately stacked. The first inductor 31c may include a first coil via 31c-3 vertically connected to the first coil pattern 31c-1, and may include a first lead-out portion 31c-4 electrically connected to the at least one first coil pattern 31c-1 and drawn out to a surface of the inductor 31c.

For example, the second inductor 32c may have a stack structure in which at least one second coil pattern 32c-1 and at least one second coil insulating layer 32c-2 are alternately stacked, may include a second coil via 32c-3 vertically connected to the second coil pattern 32c-1. The second inductor 32c may include a second lead-out portion 32c-4 electrically connected to the at least one second coil pattern 32c-1 and drawn out to a surface of the second inductor 32c. For example, the first and second inductors 31c and 32c may be implemented as a single inductor package 33.

The angular position identification layer 20b may include a first angular position identification layer 21b and a second angular position identification layer 22b. Each of the first and second angular position identification layers 21b and 22b may be disposed to surround a rotational axis (e.g., X axis) of the rotor 11 and rotate according to rotation of the rotor 11, and may have a width varying depending on an angular position of the rotor 11.

An angular position of the rotor 11 corresponding to a maximum width of the first angular position identification layer 21b may be different from an angular position of the rotor 11 corresponding to a maximum width of the second angular position identification layer 22b. For example, a normal direction of a portion corresponding to the maximum width of the first angular position identification layer 21b may be a −Z direction, and a normal direction of a portion corresponding to a maximum width of the second angular position identification layer 22b may be a +Y direction.

Accordingly, an angular position of the rotor 11 corresponding to the maximum value of the first inductance of the first inductor 31c may be different from an angular position of the rotor 11 corresponding to the maximum value of the second inductance of the second inductor 31c. Accordingly, the second inductance of the second inductor 32c may be smaller than the maximum value of the first inductance of the first inductor 31c when the angular position of the rotor 11 corresponds to the maximum value of the first inductance, and the first inductance of the first inductor of the first inductor 31c may be smaller than the maximum value of the second inductance of the second inductor 32c when the angular position of the rotor 11 corresponds to the maximum value of the second inductance.

Accordingly, an integrated parameter to which the first and second inductances of the first and second inductors 31c and 32c are applied as first and second variables may have a higher correlation with the angular position of the rotor 11, and angular position sensitivity of the integrated parameter according to rotation of the rotor 11 may be higher than sensitivity of each of the first and second inductances of the first and second inductors 31c and 32c.

The first and second angular position identification layers 21b and 22b may be disposed such that portions corresponding to the maximum widths of the first and second angular position identification layers 21b and 22b may not overlap each other in the rotation direction of the rotor 11. For example, a smaller value of two X-direction coordinate values of the portion corresponding to the maximum width of the second angular position identification layer 22b may be larger than a larger value of the two X-direction coordinate values of the portion corresponding to the maximum width of the first angular position identification layer 21b.

Accordingly, electromagnetic influence of an eddy current of one of the first and second angular position identification layers 21b and 22b on the other may be reduced, such that precision and accuracy of the angular position identification of the rotor 11 may improve.

The maximum width of each of the first and second angular position identification layers 21b and 22b may occur in a number of one per one turn around the rotational axis (e.g., X axis), and the minimum width of each of the first and second angular position identification layers 21b and 22b may occur in a number of one per one turn around the rotational axis (e.g., X axis). For example, each of the first and second angular position identification layers 21b and 22b may have a pattern repeated in one cycle per one turn of the rotational axis (e.g., X axis).

Accordingly, an error in precision/accuracy of the angular position identification of the rotor 11 according to the deviation between a portion and the other portion of one turn of each of the first and second angular position identification layer 21b and 22b may not occur, and an error in precision/accuracy of the angular position identification of the rotor 11 according to a difference between a designed shape and an actually manufactured shape of each of the first and second angular position identification layer 21b and 22b and may also decrease. Also, linearity of change of the integrated parameter of the first and second inductors 31c and 32c according to changes of the angular position of the rotor 11 may be improved.

Referring to FIG. 5C, the rotor apparatus 100i may include an angular position identification layer 20c, and the angular position identification layer 20c may include a first angular position identification layer 21c and a second angular position identification layer 22c.

A width between a portion corresponding to a maximum width of each of the first and second angular position identification layers 21c and 22c and a portion corresponding to a minimum width thereof may be shorter than that of the first and second angular position identification layers 21c and 22c illustrated in FIGS. 5A and 5B.

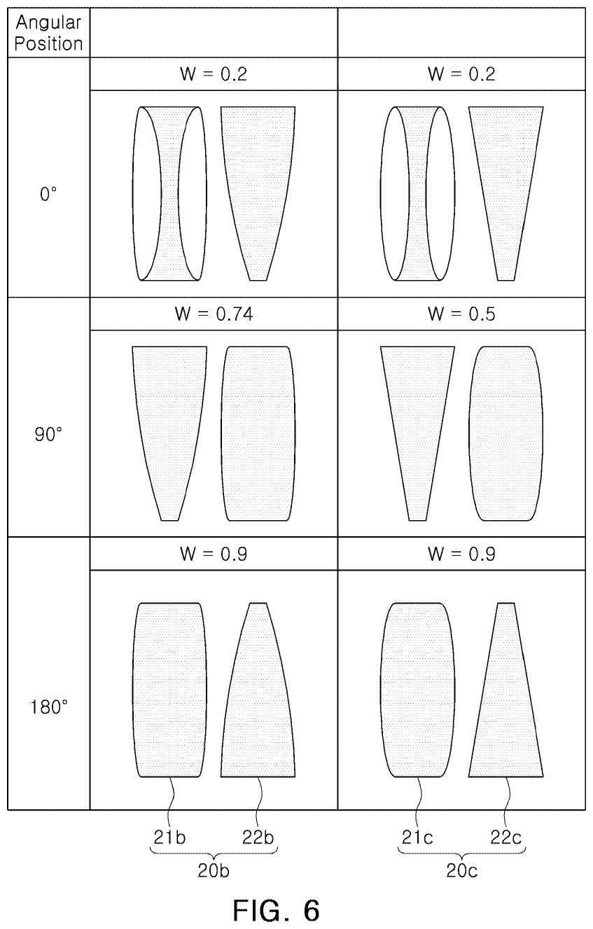

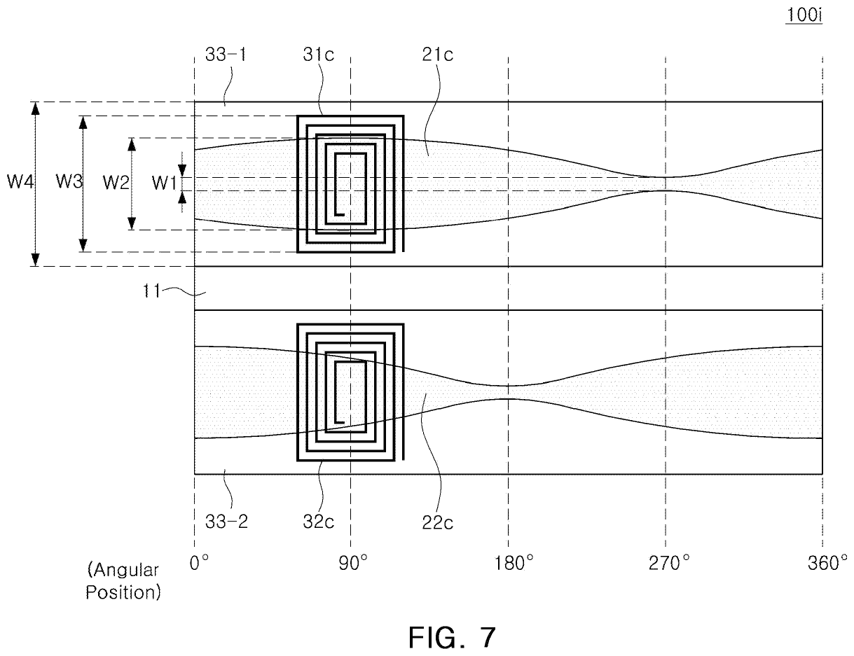

FIG. 6 is a view illustrating a width of an angular position identification layer of a rotor apparatus and corresponding relationship between angular positions, according to an example.

Referring to FIG. 6, a maximum width and a minimum width of the first and second angular position identification layers 21b and 22b illustrated in FIGS. 5A and 5B may be 0.9 mm and 0.2 mm, respectively, and a maximum width and a minimum width of the first and second angular position identification layers 21c and 22c illustrated in FIG. 5C may also be 0.9 mm and 0.2 mm, respectively.

A width of a center portion between a portion corresponding to the maximum width of the first and second angular position identification layers 21b and 22b and a portion corresponding to the minimum width thereof, illustrated in FIGS. 5A and 5B, may be 0.74 mm, and a width of a center portion between a portion corresponding to the maximum width of the first and second angular position identification layers 21c and 22c and a portion corresponding to the minimum width thereof, illustrated in FIG. 5C, may be 0.5 mm.

That is, the width of the center portion between the portion corresponding to the maximum width of the first angular position identification layer 21c and the portion corresponding to the minimum width of the first angular position identification layer 21c may be substantially the same as an average value of the maximum width and the minimum width of the first angular position identification layer 21c. The width of the center portion between the portion corresponding to the maximum width of the second angular position identification layer 22c and the portion corresponding to the minimum width of the second angular position identification layer 22c may be substantially the same as an average value of the maximum width and the minimum width of the second angular position identification layer 22c.

Accordingly, a rate of change according to the change of the angular position of the rotor 11 of the integrated parameter of the first and second inductors 31c and 32c may be more uniform than in an entire angular position range (360 degrees) of the rotor 11, and linearity of change of the integrated parameter according to the change of the angular position of the rotor 11 may be improved.

FIG. 7 is an exploded view illustrating a side surface of the rotor 11 of the rotor apparatus 100i of FIG. 5C, according to an example.

Referring to FIG. 7, a cycle in which a minimum width W1 of the first and second angular position identification layers 21c and 22c of the rotor apparatus 100i is repeated may be 360 degrees, and a cycle in which the maximum width W2 of the first and second angular position identification layers 21c and 22c is repeated may be 360 degrees.

For example, the first angular position identification layer 21c may have the maximum width W2 at an angular position of 90 degrees, and may have the minimum width W1 at an angular position of 270 degrees. The second angular position identification layer 22c may have a maximum width at angular position of 0 degrees and a minimum width at angular position of 180 degrees. Accordingly, one of the first and second angular position identification layers 21c and 22c may be disposed to surround the side surface of the rotor 11 by further rotating by ¼ turn (90 degrees) than the other.

Accordingly, the integrated parameter to which the first and second inductance of the first and second inductors 31c and 32c are applied as first and second variables may have a higher correlation with the angular position of the rotor 11, and linearity of change of the integrated parameter according to the change of the angular position may be improved.

For example, each of the first and second angular position identification layers 21c and 22c may have a sinusoidal-wave shaped boundary line, and the first and second angular position identification layers 21c and 22c may have the same shape.

Accordingly, a parameter according to arc-tangent processing of the first and second inductances of the first and second inductors 31c and 32c may change at a constant rate of change according to the change in angular position.

The greater the difference between the maximum width W2 and the minimum width W1 of the first and second angular position identification layers 21c and 22c, the greater the rate of change of the integrated parameter of the first and second inductances of the first and second inductors 31c and 32c according to the change of the angular position may be, and accordingly, sensitivity for the angular position of the integrated parameter may improve.

The greater the maximum width W2, the greater the difference between the maximum width W2 and the minimum width W1 of the first and second angular position identification layers 21c and 22c may be.

However, when the maximum width W2 of the first and second angular position identification layers 21c and 22c is excessively long, the rate of change of the first and second inductances of the first and second inductors 31c and 32c according to the rotation of the rotor 11 in the region neighboring to a portion corresponding to the maximum width of the first and second angular position identification layers 21c and 22c may decrease. Accordingly, a maximum limit width W4 of the first and second angular position identification layers 21c and 22c, at which the correlation between the integrated parameter of the first and second inductance and the angular position is improved, may be present.

The maximum width W2 of the first angular position identification layer 21c may be less than or equal to 1.2 times the maximum width W3 of the first inductor 31c in a corresponding direction, and the maximum width of the second angular position identification layer 22c may be less than or equal to 1.2 times the maximum width of the second inductor 32c in a corresponding direction.

Accordingly, the rotor apparatus 100i may obtain high angular position sensitivity due to the large difference between the maximum width W2 and the minimum width W1 of the first and second angular position identification layers 21c and 22c, and the reduction in the rate of change of the first and second inductance of the first and second inductors 31c and 32c caused by an excessive increase of the maximum width W2 of the first and second angular position identification layers 21c and 22c may be prevented. Accordingly, high linearity of the integrated parameter of the first and second inductance of the first and second inductors 31c and 32c may be obtained.

For example, the maximum width W2 of the first angular position identification layer 21c and the maximum width W3 of the first inductor 31c in the corresponding direction may be substantially the same, and the maximum width of the second angular position identification layer 22c and the maximum width of the second inductor 32c in a corresponding direction may be substantially the same.

When the maximum width W2 of the first angular position identification layer 21c is from 0.9 times to 1.1 times or less the maximum width W3 of the first inductor 31c in a corresponding direction, the maximum width W2 of the first angular position identification layer 21c and the maximum width W3 of the first inductor 31c in a corresponding direction may be substantially the same. When the maximum width of the second angular position identification layer 22c is from 0.9 times to 1.1 times the maximum width of the second inductor 32c in a corresponding direction, the maximum width of the second angular position identification layer 22c and the maximum width of the second inductor 32c in a corresponding direction may be substantially the same. Accordingly, sensitivity and linearity for the angular position of the rotor apparatus 100i may be improved.

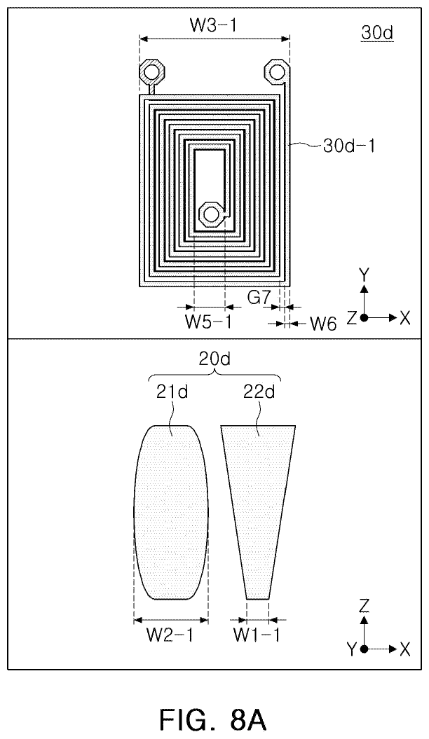

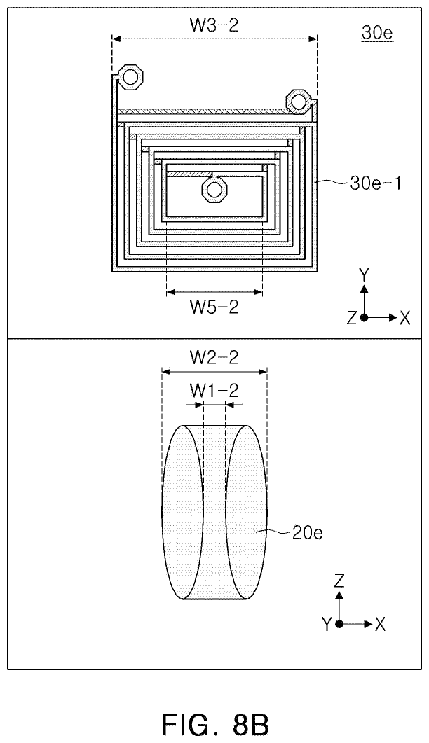

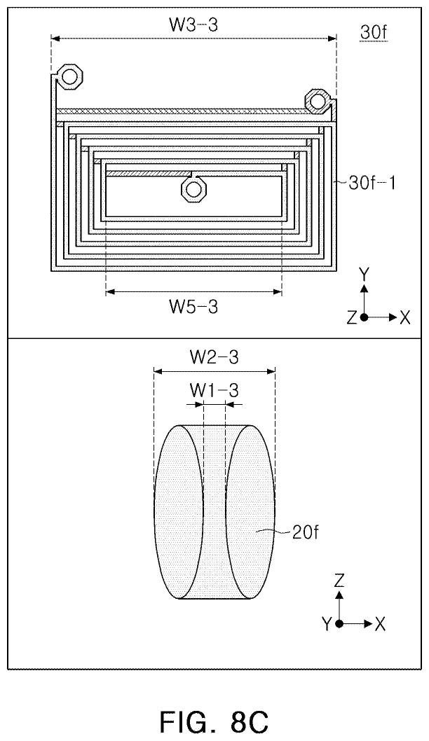

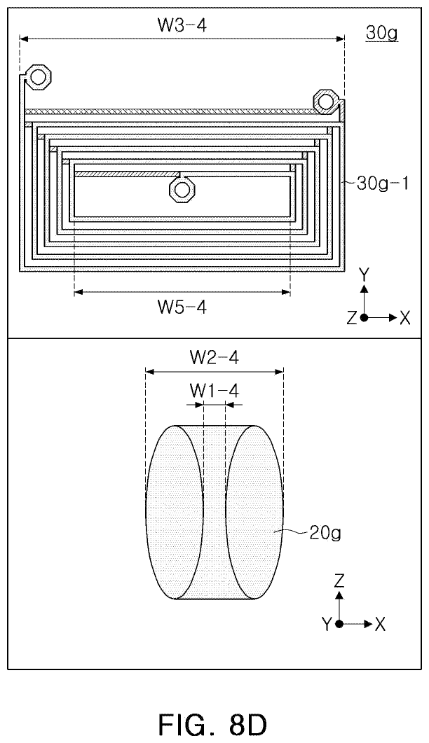

FIGS. 8A to 8D are views illustrating a relationship between a width of an angular position identification layer and a width of an inductor of a rotor apparatus, according to an example.

Referring to FIG. 8A, first and second angular position identification layers 21d and 22d of an angular position identification layer 20d may have a minimum width W1-1 and a maximum width W2-1, respectively.

An inductor 30d may have a coil pattern 30d-1 having a maximum width W3-1 and a minimum width W5-1. For example, the coil pattern 30d-1 may have a quadrangular shape, and may have a line width W6 and a line gap G7.

The coil pattern 30d-1 of the inductor 30d may have a wound shape, wound a plurality of times. The maximum width of the first and second inductors 31c and 32c illustrated in FIG. 7 may be the maximum width of an outermost winding of the coil pattern 30d-1 in a corresponding direction (e.g., the X direction).

The minimum width W5-1 of the inductor 30d may be the minimum width of an innermost winding of the coil pattern 30d-1 in a corresponding direction (e.g., the X direction), and may be greater than the minimum width W1-1 of each of the first and second angular position identification layers 21d and 22d.

For example, the number of stacked layers of the coil pattern 30d-1 may be 7, the number of windings of each layer of the coil pattern 30d-1 may be 8, the maximum width W3-1 may be 0.9 mm, and the minimum width W1-1 and the maximum width W2-1 of the angular position identification layer 20d may be 0.2 mm and 0.89 mm, respectively.

Referring to FIG. 8B, an angular position identification layer 20e may have a minimum width W1-2 and a maximum width W2-2, and a coil pattern 30e-1 of an inductor 30e may have a maximum width W3-2 and a minimum width W5-2. The maximum width W2-2 of the angular position identification layer 20e may be greater than that of the example illustrated in FIG. 8A, and the maximum width W3-2 of the coil pattern 30e-1 may be greater than that of the example illustrated in FIG. 8A.

For example, the number of stacked layers of the coil patterns 30e-1 may be 12, the number of windings of each layer of the coil pattern 30e-1 may be 4.5, the maximum width W3-2 may be 1.1 mm, and the minimum width W1-2 and the maximum width W2-2 of the angular position identification layer 20e may be 0.2 mm and 1 mm, respectively.

Referring to FIG. 8C, an angular position identification layer 20f may have a minimum width W1-3 and a maximum width W2-3, a coil pattern 30f-1 of an inductor 30f may have a maximum width W3-3 and a minimum width W5-3. The maximum width W2-3 of the angular position identification layer 20f may be longer than that of the example illustrated in FIG. 8B, and the maximum width W3-3 of the coil pattern 30f-1 may be longer than that of the example illustrated in FIG. 8B.

For example, the number of stacked layers of the coil pattern 30f-1 may be 12, the number of windings of each layer of the coil pattern 30f-1 may be 4.5, the maximum width W3-3 may be 1.35 mm, and the minimum width W1-3 and the maximum width W2-3 of the angular position identification layer 20f may be 0.2 mm and 1.25 mm, respectively.

Referring to FIG. 8D, an angular position identification layer 20g may have a minimum width W1-4 and a maximum width W2-4, and a coil pattern 30g-1 of an inductor 30g may have a maximum width W3-4 and a minimum width W5-4. The maximum width W2-4 of the angular position identification layer 20g may be longer than that of the example illustrated in FIG. 8C, and the maximum width W3-4 of the coil pattern 30g-1 may be longer than that of the example illustrated in FIG. 8C.

For example, the number of stacked layers of the coil pattern 30g-1 may be 12, the number of windings of each layer of the coil pattern 30g-1 may be 4.5, the maximum width W3-4 may be 1.6 mm, and the minimum width W1-4 and the maximum width W2-4 of the angular position identification layer 20g may be 0.2 mm and 1.50 mm, respectively.

Thus, the maximum width of the angular position identification layer of the rotor apparatus in the examples may be determined as a value adaptive to the maximum width of the inductor.

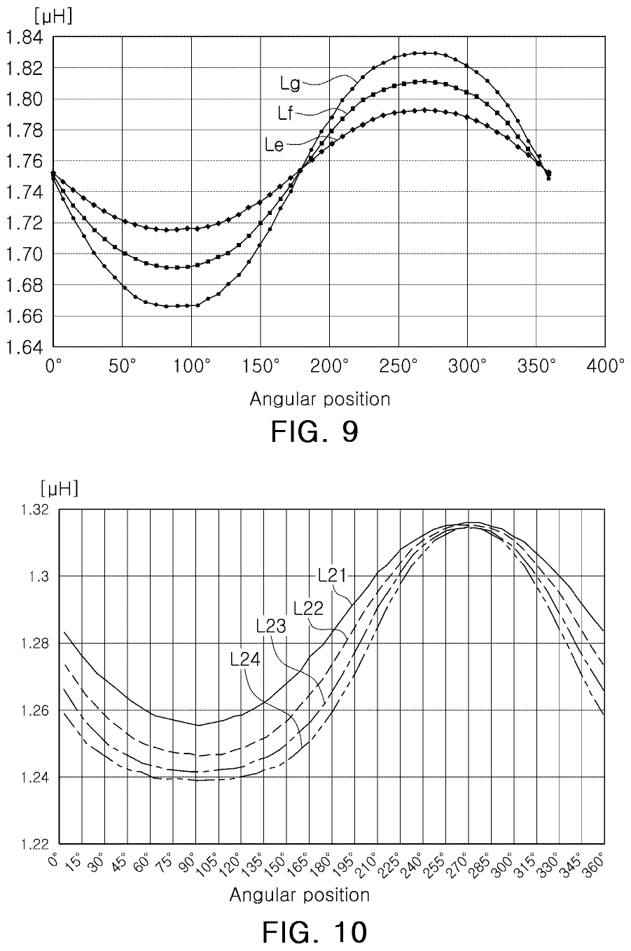

FIG. 9 is a graph illustrating inductance (a median normalized) of an inductor according to an angular position of a rotor of the rotor apparatus illustrated in FIGS. 8B to 8D.

Referring to FIG. 9, a rate of change of inductance Lf of the inductor according to the angular position of a specific point (e.g., a point facing the inductor) of the rotor illustrated FIG. 8C may be greater than inductance Le of the inductor according to the angular position of a specific point of the rotor illustrated in FIG. 8B, and may be less than a rate of change of inductance Lg of the inductor according to angular position of a specific point of the rotor illustrated in FIG. 8D.

For example, the maximum value and the average value of the inductance Le may be 1.424 μH and 1.378 μH, respectively, and a difference between the maximum value and the minimum value of the inductance Le may be 0.077 μH. The inductance Le illustrated in FIG. 9 may be a value normalized (Le/Lf) with reference to the inductance Lf.

For example, the maximum value and the average value of the inductance Lf may be 1.818 μH and 1.751 μH, respectively, and a difference between the maximum value and the minimum value of the inductance Lf may be 0.120 μH.

For example, the maximum value and the average value of the inductance Lg may be 2.203 μH and 2.115 μH, respectively, and a difference between the maximum value and the minimum value of the inductance Lg may be 0.163 μH. The inductance Lg in FIG. 9 is a value normalized (Lg/Lf) with reference to the inductance Lf.

The larger the maximum width of the angular position identification layer and the maximum width of the inductor, the greater the rate of change of inductance of the inductor may be, and the higher the angular position sensitivity may be.

FIG. 10 is a graph illustrating inductance of an inductor according to a width of an angular position identification layer of a rotor apparatus, according to an example.

Referring to FIG. 10, inductance L21 of the inductor according to the angular position of a specific point (e.g., a point facing the inductor) of the rotor illustrated in FIG. 8A may be closest to a sine wave.

For example, the maximum value and the average value of the inductance L21 may be 1.32 μH and 1.288 μH, respectively, and a difference between the maximum value and the minimum value of the inductance L21 may be 0.055 μH.

In a state in which the maximum width of the inductor is fixed, a rate of change of the inductance L22 of the inductor of when the maximum width of the angular position identification layer is 1.09 mm, a rate of change of the inductance L23 of the inductor of when the maximum width of the angular position identification layer is 1.29 mm, and a rate of change of the inductance L24 of the inductor of when the maximum width of the angular position identification layer is 1.49 mm may decrease around the minimum value of the inductance L22, L23, and L24.

In other words, when the maximum width of the angular position identification layer is (1.09/0.9) times the maximum width of the inductor, the rate of change of the inductance L22, L23, and L24 may significantly decrease around the minimum value of the inductance L22, L23, and L24.

When the maximum width of the angular position identification layer is less than (1.09/0.9) times the maximum width of the inductor, the phenomenon in which the rate of change of the inductance L22, L23, and L24 significantly decreases around the minimum value of the inductance L22, L23, and L24 may be reduced.

Also, when the maximum width of the angular position identification layer is less than 1.2 times the maximum width of the inductor in the corresponding direction, the phenomenon in which the rate of change of the inductance decreases significantly around the minimum value as the maximum width of the angular position identification layer excessively increases may be reduced.

When the first and second inductances of the first and second inductors form a phase difference of 90 degrees, one of the first and second inductances may correspond to {sin(angular position)} and the other may correspond to {cos(angular position)}.

In the trigonometric function model, an angle from the origin to one point of the circle may correspond to the angular position of the rotor, the distance from the origin to one point of the circle may be r, and an x-direction vector value and a y-direction vector value from the origin to one point of the circle may be x and y, respectively.

{sin(angular position)} may be (y/r), and {cos(angular position)} may be (x/r). {tan(angular position)} may be (y/x), may be {sin(angular position)}/{cos(angular position)}, and may be {(second inductance)/(first inductance)}.

Accordingly, arc-tangent {(second inductance)/(first inductance)} may correspond to the angular position and may be an arc-tangent processing value.

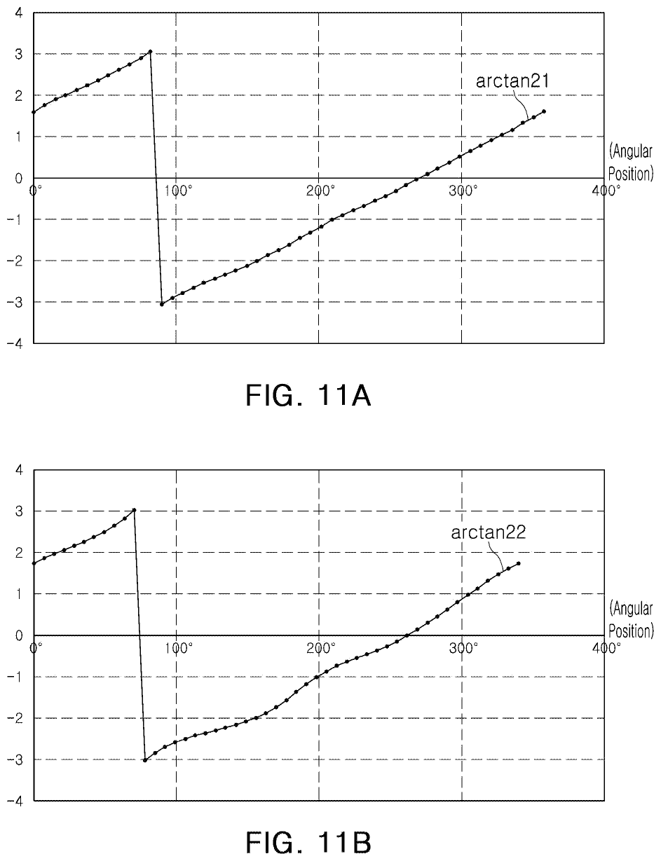

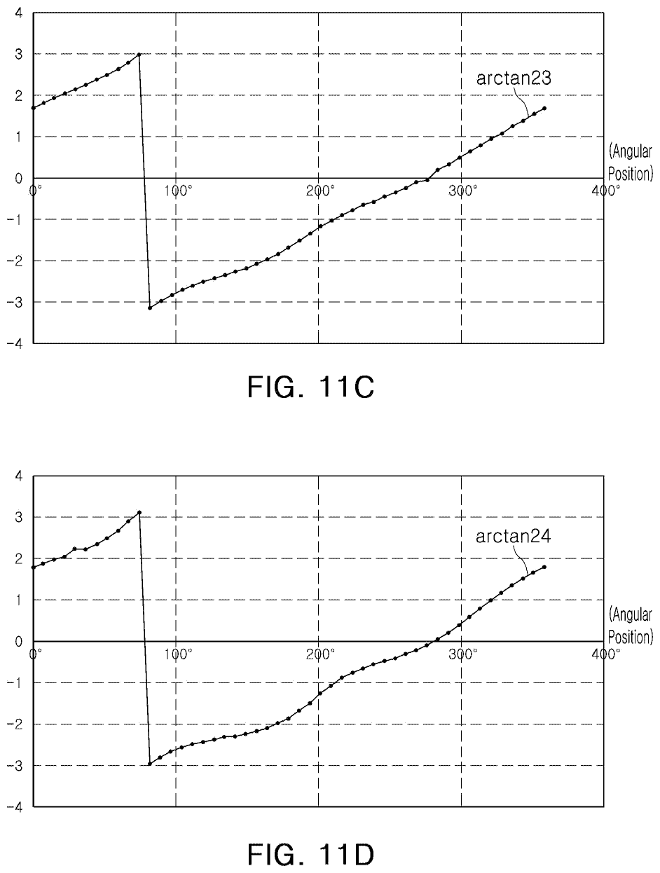

FIGS. 11A and 11D are graphs illustrating an arc-tangent processing value according to a width of an angular position identification layer of a rotor apparatus, according to examples.

Referring to FIG. 11A, an arc-tangent processing value (arc-tangent21) corresponding to the inductance L21 illustrated in FIG. 10 may be linear. Thus, the angular position of the rotor may be efficiently detected.

Referring to FIG. 11B, the linearity of the arc-tangent processing value (arc-tangent22) corresponding to the inductance L22 illustrated in FIG. 10 may be lower than the linearity of the arc-tangent processing value illustrated in FIG. 11A.

Referring to FIG. 11C, the linearity of the arc-tangent process value (arc-tangent23) corresponding to the inductance L23 illustrated in FIG. 10 may be lower than that of the arc-tangent process value illustrated in FIG. 11B.

Referring to FIG. 11D, the linearity of the arc-tangent processing value (arc-tangent24) corresponding to the inductance L24 illustrated in FIG. 10 may be lower than the linearity of the arc-tangent processing value illustrated in FIG. 11C.

Accordingly, when the maximum width of the angular position identification layer is less than or equal to 1.2 times the maximum width of the inductor in a corresponding direction, the arc-tangent processing value of the first and second inductances of the first and second inductors may have high linearity.

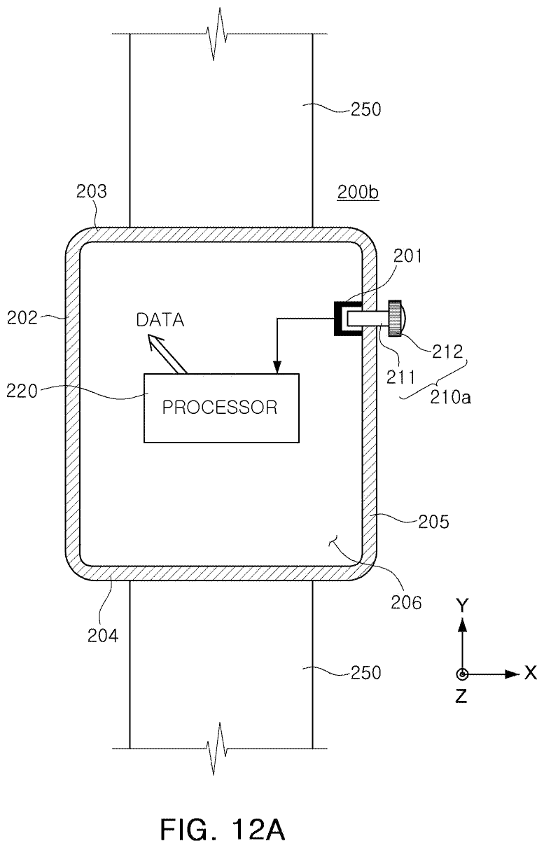

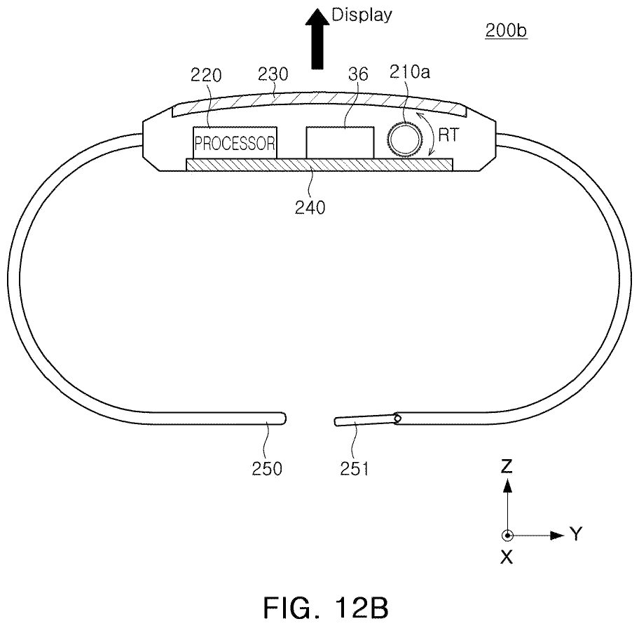

FIGS. 12A and 12B are views illustrating an electronic device 200b including a rotor apparatus 210a, according to an example.

Referring to FIG. 12A, the electronic device 200b may include a main body including at least two among a first surface 205, a second surface 202, a third surface 203, and a fourth surface 204.

For example, the electronic device 200b may be implemented by a smart watch, a smart phone, a personal digital assistant, a digital video camera, and a digital still camera, a network system, a computer, a monitor, a tablet, a laptop, a netbook, a television, a video game, an automotive device, or the like, but is not limited to such examples.

The electronic device 200b may include a processor 220, a storage element for storing information, such as a memory or a storage, and a communication element for remotely transmitting and receiving information, such as a communication modem or an antenna.

The processor 220 may be disposed in an internal space 206 of the main body. For example, the processor 220 may include a central processing unit (CPU), a graphic processing unit (GPU), a microprocessor, an application specific integrated circuit (ASIC), field programmable gate arrays (FPGA), and the like, and may have multiple cores. For example, the processor 220 may input/output information for the storage element or the communication element.

The processor 220 may arc-tangent process a value including a denominator variable corresponding to one of the inductances of first and second inductors of the rotor apparatus 210a and a numerator variable corresponding to the other of the inductances of first and second inductors, thereby generating an angular position value. Accordingly, the electronic device 200b may efficiently detect angular position information of the rotor apparatus 210a.

For example, the rotor apparatus 210a may include a rotor 211 and a rotating head 212, and may be disposed on the first surface 205 of the main body.

The housing 201 may surround at least a portion of the rotor apparatus 210a. The housing 201 may be coupled to the first surface 205 of the main body. For example, the housing 201 and the main body may be implemented by an insulating material such as plastic.

The generated angular position value may be transmitted to the processor 220. For example, the processor 220 may generate information based on the received angular position value, may transmit the generated information to the storage element or the communication element, and may control the display member to output display information in the Z direction on the basis of the generated information.

Referring to FIGS. 12A and 12B, the electronic device 200b may be connected to any one or any combination of any two or more of the first, second, third and fourth surfaces 205, 202, 203, and 204 of the main body, and may further include a strap 250 that is more flexible than the main body.

Accordingly, since the strap 250 may be disposed over a user (or clothing) of a user of the electronic device 200b, the user may use the electronic device 200b conveniently. For example, one end and the other end of the strap 250 may be coupled to each other through a coupling portion 251.

Referring to FIG. 12B, the electronic device 200b may include a display member 230 and an electronic device substrate 240, and may further include an angular position detection circuit 36.

The display member 230 may output display information in a normal direction (e.g., Z direction) different from a normal direction (e.g., X direction and/or Y direction) of the first, second, third and fourth surfaces 205, 202, 203, and 204 of the main body. The normal direction of the display member 230 and the normal direction of the display surface of the main body of the electronic device 200b may be the same.

At least a portion of the display information output by the display member 230 may be based on information generated by the processor 220. For example, the processor 220 may transmit the display information based on the generated information to the display member 230.

For example, the display member 230 may have a structure in which a plurality of display cells are two-dimensionally arranged, and may receive a plurality of control signals based on operation information of the electronic device from the processor 220 or a separate processor, and the plurality of display cells may be configured such that whether to display and/or a color may be determined on the basis of a plurality of control signals. For example, the display member 230 may further include a touch screen panel, and may be implemented using a relatively flexible material such as an OLED.

The electronic device substrate 240 may provide a dispositional space for the processor 220 and may provide an information transmission path between the processor 220 and the display member 230. For example, the electronic device substrate 240 may be implemented as a printed circuit board (PCB).

The angular position sensing circuit 36 may be implemented similarly to the angular position sensing circuit illustrated in FIG. 1, and may be separated from the rotor apparatus 210a and disposed on the substrate 240, differently from the angular position sensing circuit illustrated in FIG. 1.

According to the aforementioned examples, the angular position identification efficiency (e.g., at least one of sensitivity, precision, and accuracy of angular position identification) of a rotor may be improved, and linearity of an angular position identification parameter (e.g., an arc-tangent processing value) may also improve.

The processor 220 in FIGS. 1-12B that performs the operations described in this application is implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12B that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While specific examples have been illustrated and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rotor apparatus, comprising:
a rotor configured to rotate around a rotational axis;
a first angular position identification layer disposed to surround the rotational axis, configured to rotate according to rotation of the rotor, and having a width varying with angular positions of the rotor; and
a second angular position identification layer disposed to surround the rotational axis, configured to rotate according to the rotation of the rotor, and having a width varying with angular positions of the rotor,
wherein an angular position of the rotor, among the angular positions of the rotor, corresponding to a maximum width of the first angular position identification layer is different from an angular position of the rotor, among the angular positions of the rotor, corresponding to a maximum width of the second angular position identification layer,
wherein the maximum width of the first angular position identification layer is less than or equal to 1.2 times a maximum width, in a direction corresponding to a direction of the maximum width of the first angular position identification layer, of a first inductor configured to output magnetic flux towards the first angular position identification layer, and
wherein the maximum width of the second angular position identification layer is less than or equal to 1.2 times a maximum width, in a direction corresponding to a direction of the maximum width of the second angular position identification layer, of a second inductor configured to output magnetic flux towards the second angular position identification layer.

2. The rotor apparatus of claim 1, wherein the first and second angular position identification layers are disposed such that a portion corresponding to the maximum width of the first angular position identification layer and a portion corresponding to the maximum width of the second angular position identification layer do not overlap each other in a rotation direction of the rotor.

3. The rotor apparatus of claim 1, wherein the maximum widths of the first and second angular position identification layers occur once per one turn around the rotational axis, and
wherein a minimum width of each of the first and second angular position identification layers occurs once per one turn around the rotational axis.

4. The rotor apparatus of claim 3, wherein the first and second angular position identification layers have substantially the same shape, and
wherein one of the first and second angular position identification layers is disposed to rotate further than the other of the first and second angular position identification layers by approximately ¼ turn and to surround a side surface of the rotor.

5. The rotor apparatus of claim 3, wherein a width of a center portion between a portion corresponding to the maximum width of the first angular position identification layer and a portion corresponding to the minimum width of the first angular position identification layer is equal to an average value of the maximum width of the first angular position identification layer and the minimum width of the first angular position identification layer, and
wherein a width of a center portion between a portion corresponding to the maximum width of the second angular position identification layer and a portion corresponding to the minimum width of the second angular position identification layer is equal to an average value of the maximum width of the second angular position identification layer and the minimum width of the second angular position identification layer.

6. The rotor apparatus of claim 3, wherein each of the first and second angular position identification layers has a sinusoidal-wave shaped boundary line.

7. The rotor apparatus of claim 6, further comprising:
a first inductor including a first coil pattern having a quadrangular shape; and
a second inductor including a second coil pattern having a quadrangular shape.

8. The rotor apparatus of claim 1, wherein the first coil pattern is wound a plurality of times,
wherein the second coil pattern is wound a plurality of times,
wherein the maximum width of the first inductor is a maximum width of an outermost winding of the first coil pattern in the direction corresponding to the direction of the maximum width of the first inductor, and
wherein the maximum width of the second inductor is a maximum width of an outermost winding of the second coil pattern in a direction corresponding to a direction of the maximum width of the second inductor.

9. The rotor apparatus of claim 8, wherein a minimum width of the first angular position identification layer is less than a minimum width of an innermost winding of the first coil pattern in a direction corresponding to a direction of the minimum width of the first angular position identification layer, and
wherein a minimum width of the second angular position identification layer is less than a minimum width of an innermost winding of the second coil pattern in a direction corresponding to the minimum width of the second angular position identification layer.

10. The rotor apparatus of claim 1, wherein the maximum width of the first angular position identification layer is less than or equal to 1.1 times a maximum width of the first inductor in the direction corresponding to the direction of the maximum width of the first angular position identification layer, and
wherein the maximum width of the second angular position identification layer is less than or equal to 1.1 times a maximum width of the second inductor in a corresponding direction.

11. The rotor apparatus of claim 10,
wherein the maximum width of the first angular position identification layer is greater than 0.9 times the maximum width of the first inductor, and
wherein the maximum width of the second angular position identification layer is greater than 0.9 times the maximum width of the second inductor in a corresponding direction.

12. The rotor apparatus of claim 1, further comprising:
a permeability layer disposed to surround the rotational axis and having a permeability higher than a permeability of the rotor.

13. The rotor apparatus of claim 12, wherein each of the first and second angular position identification layers is disposed on a side surface of the rotor, and
wherein the permeability layer is disposed to overlap the first and second angular position identification layers in a normal direction of the side surface of the rotor.

14. The rotor apparatus of claim 12, wherein each of the first and second angular position identification layers includes any one or any combination of any two or more of copper, silver, gold, and aluminum, and
wherein the rotor includes a plastic material.

15. The rotor apparatus of claim 1,
wherein each of the first and second angular position identification layers includes any one or any combination of any two or more of copper, silver, gold, and aluminum, and
wherein the rotor has a permeability higher than a permeability of each of the first and second angular position identification layers.

16. An electronic device, comprising:
the rotor apparatus of claim 1;
first and second inductors; and
a processor configured to generate an angular position value by arc-tangent processing a value including a denominator variable corresponding to one of inductances of the first and second inductors and a numerator variable corresponding to a remaining inductance.

17. The electronic device of claim 16, further comprising:
a fixing member having a through-hole penetrated by the rotor; and
a substrate disposed on the fixing member,
wherein the first and second inductors are disposed on the substrate.

18. The electronic device of claim 16, further comprising:
a display member configured to output display information based on the angular position value,
wherein a direction of the rotational axis is different from a direction in which the display member outputs the display information.

19. The electronic device of claim 18, further comprising:
a main body accommodating the processor; and
a strap coupled to a second side surface of the main body and more flexible than the main body,
wherein the rotor apparatus is disposed on a first side surface of the main body.

20. A rotor apparatus, comprising:
a rotor configured to rotate around a rotational axis;
a first angular position identification layer disposed on a surface of the rotor around the rotational axis, and having a non-uniform width in a direction of the rotational axis; and
a second angular position identification layer disposed on the surface of the rotor around the rotational axis, and having a non-uniform width in the direction of the optical axis,
wherein a maximum width of the first angular position identification layer and a maximum width of the second angular position identification layer are located at different angular positions of the rotor,
wherein the maximum width of the first angular position identification layer in a direction of the rotational axis is less than or equal to 1.2 times a maximum width of a first inductor corresponding to the first angular position identification layer, and
wherein the maximum width of the second angular position identification layer is less than or equal to 1.2 times a maximum width of a second inductor corresponding to the second angular position identification layer.

21. The rotor apparatus of claim 20, wherein the second angular position identification layer is spaced apart from the first angular position identification layer in the direction of the rotational axis.

22. The rotor apparatus of claim 20, wherein the rotor has a permeability higher than a permeability of each of the first and second angular position identification layers.

23. The rotor apparatus of claim 20, wherein the maximum widths of the first and second angular position identification layers occur only once per one turn around the rotational axis.
